(19) United States
(12) Patent Application Publication
(10) Pub. No.: US 2010/0152353 A1
(43) Pub. Date: Jun. 17, 2010

(54) Process to convert thermoset plastic into recyclable and reusable plastic

(76) Inventor: Poon O. Kuan, Singapore (SG)

Correspondence Address: KEVIN J. MCNEELY, ESQ., 5335 WISCONSON AVENUE, NW, SUITE 440, WASHINGTON, DC, 20015, US

(21) Appl. No.: 12/066,288

(22) PCT Filed: Aug. 25, 2006
(86) PCT No.: PCT/MY2006/000005

§ 371 Date: Mar. 10, 2008

(30) Foreign Application Priority Data
Sep. 12, 2005 (MY) PI20054288

(51) Int. Cl. C08K 5/101

(52) U.S. Cl. 524/315

(57) ABSTRACT

The invention is about a process to recycle cured thermoset plastic. The process involves using a small quantity of thermoplastic and mixing it with cured thermoset plastic (about 70% (minimum) by weight of all ingredients used) under heat and pressure. A chemical, i.e. a thermoplastic polymer grafted with functional group, is added to create the bonding between the thermoplastic and cured thermoset plastic used; and lubricants are also added to improve the process and enhance the quality of the end product. Although the end product has cured thermoset plastic as a main constituent, it behaves like thermoplastic. It can undergo reversible physical change: i.e. it can change its physical state from solid to molten under heat; and then reverse itself back to solid when heat is removed. The physical change may be repeated without any noticeable change or deterioration in the end product.

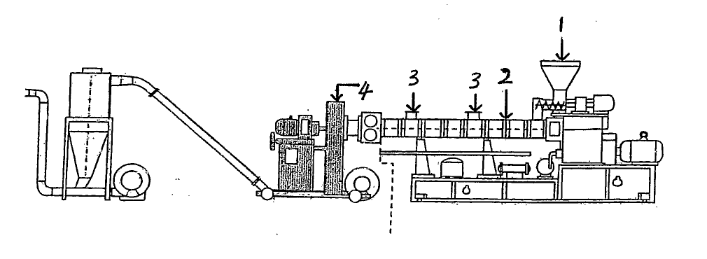

### 1. TECHNICAL FIELD

The invention is about a process for recycling and reusing cured thermoset plastic—a material so far universally believed to be and accepted as un-recyclable by industrialists as well as scientifists. The process uses cured thermoset plastic and thermoplastic as two essential ingredients; and some chemicals (to act as binding promoter): and the end result of the process is a new recyclable and reusable plastic.

### 2. BACKGROUND ART

Plastic (thermoplastic as well as thermoset plastic) is a wonder material. Generally speaking, plastic has high heat tolerance, is very durable, light-weight, impermeable; and can easily be softened and moulded into different shapes. These qualities quite readily present plastic with endless possible applications and potentials. It is used for the production of a great number of industrial and domestic products and wares like phone casing, computer casing, printed circuit board, container, wrapper, window frame, table, chair, water pipe, film, textile, paint, etc. The width of the plastic product range stands as a testimony of its versatility and utility.

Unfortunately, because of its durable character, plastic degrades very slowly over time. As a result, disposal of plastic materials, products and wares becomes a very difficult environmental issue. The environment would be unnecessarily burdened if plastic materials, products and wares are disposed of straightaway without any prior treatment. It has therefore become a common practice to incinerate them before disposal. Heat from incineration will break down their molecular structure and destroy their durable character. However, such treatment consumes fuel and releases certain amount of toxic gas into the environment.

Recycling is a good alternative. But not all plastics are readily or easily reusable/recyclable. Plastics in general are classified in two broadly accepted categories: (i) thermoplastic; and (ii) thermoset plastic. [There are other classifications (e.g. elastomer, engineering plastic, addition polymer, condensation polymer etc). But they are of no concern to the invention herein described.] Thermoplastic, given its molecular structure, can be softened, moulded and reused repeatedly by applying heat and pressure, but thermoset plastic cannot. Virgin thermoset plastic, once heated and moulded, cannot be re-heated and re-moulded again for the purposes of reuse. In other words, thermoplastic can be recycled, and in this sense thermoset plastic cannot. Virgin thermoset plastic that has been heated and moulded (in lay terms “used”) is described as cured thermoset plastic. The invention here described is about recycling and reusing cured thermoset plastic; and unless otherwise stated, all reference herein to thermoset plastic are about cured thermoset plastic.

Actually, thermoset plastic can be reused, albeit in a very limited way only. It is usually ground up and used as filler. But the material degrades easily with each cycle of reuse. Therefore, in terms of effectiveness and economy, recycling thermoset plastic falls far behind thermoplastic. Hence, more usually than not unwanted thermoset plastics are incinerated. Singapore has established itself as an important destination in the world for incineration of thermoset plastics.

### 3. DISCLOSURE OF INVENTION

### (a) General

The process herein described is invented with the objective of enabling reuse of thermoset plastic to be made in a practical, economical and effective fashion. It also entails the creation of a new reusable/recyclable plastic.

The new plastic is formed by combining thermoplastic and thermoset plastic, with the aid of chemical additives (to act as binding agent/promoter) and a lubricating system, under heat and pressure in an extruding machine. The new material thus produced is in effect a mixture of two plastic materials. For easy reference, this new plastic material will be known by the name “relivplastic”.

Relivplastic bears its own unique physical and chemical properties and characteristics. And more importantly, like thermoplastic, it too can undergo reversible physical change: i.e. it can change its physical state from solid to molten under heat; and can reverse itself back to solid when heat is removed. The process may be repeated ad infinitum without any noticeable deterioration or change in terms of its chemistry, behaviour and character. These qualities make relivplastic suitable for recycling. Further, like thermoplastic, relivplastic too can be extruded into profiles.

### (b) Chemistry

Plastic (thermoplastic and thermoset plastic alike) is the end product of a chemical process called polymerisation. Hence, in chemistry it is identified as a type of polymer. [However, not all polymers are plastic. So for avoidance of doubt, unless otherwise stated, a reference to polymer herein is a reference to plastic polymer only.] And depending on the actual polymerisation process adopted and the chemicals added, the resulting polymer could differ, one from another, quite significantly in terms of their physical and chemical properties. It is therefore not difficult for one to see that there are many different types of plastic in existence; for instance, celluloid, nylon, teflon, acrylic, epoxy, polyvinyl chloride, polyethylene, etc.

Polymer is a macromolecule, i.e. a large molecule: And polymerisation is a chemical process through which a polymer acquires its macro character. The process involves repetitive chemical reactions of simple molecule units (or monomer) to form a large molecule (polymer).

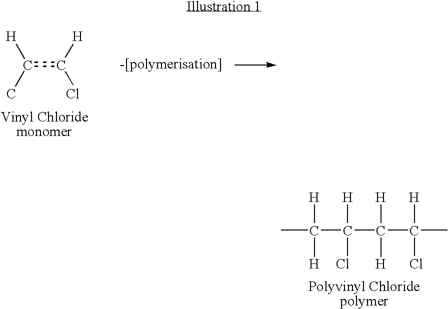

Illustration 1 shows the polymerisation of Vinyl Chloride monomers into Polyvinyl Chloride polymer. The monomers in the chain are held together in position by the forces of covalent bond.

Shown below (Illustration 2) is a monomer of Ethylene, which is a thermoplastic; and a monomer of Epoxy Resin, a thermoset plastic.

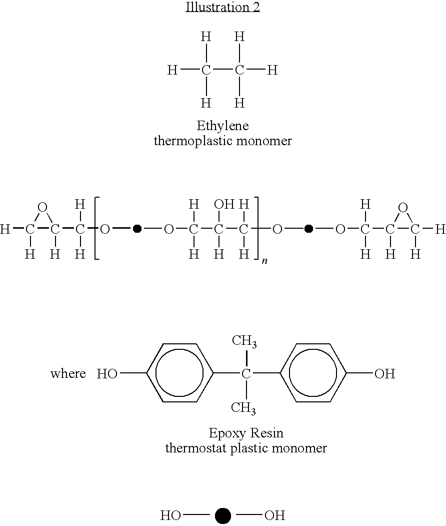

Chemically, thermoplastic and thermoset plastic do not mix. Their respective polymers will not react with one another; and link up into a long chain by the forces of covalent bond. In fact, until now there are no known scientific method or process whereby this can be achieved successfully.

The process that was invented enables thermoplastic and thermoset plastic to mix. This process represents a completely new and remarkable way of reusing thermoset plastic: And the end product of that process (i.e. relivplastic—a recyclable plastic material) represents another new and remarkable invention. Section 4 below contains a detailed description of the process.

The process aforesaid involves chemical reaction between thermoplastic and thermoset plastic: the consequence of the reaction is, the two plastics will be fused together in a homogeneous fashion—with their respective molecules being held together by the forces of Van Der Vaal.

### 4. BEST MODE FOR CARRYING OUT THE INVENTION

This section describes the best way to carry out the invention and the necessary steps to take in accomplishing the process of mixing and fusing thermoplastic and thermoset plastic together into relivplastic.

### (a) The Equipment

The FIGURE as shown in the drawing is a schematic diagram of a typical extruding machine that can be used in producing relivplastic. It is an industry-standard counter-rotating cornical twin-screw extruder.

The main functions of the extruder are: (a) melt down raw ingredients; then (b) mix them; and finally (c) extrude them. The melting down is achieved by applying heat; and the mixing is achieved by forcing molten ingredients through a pair of counter-rotating cornical screws.

Raw ingredients are first loaded into the Hopper (1). There heat will be applied to melt the ingredients. From there, the molten ingredients will flow towards the mixing chamber (2); wherein lies the twin cornicle screws. The rotatory motion of the screws will turn the molten ingredients in the mixing chamber round and round; and in that process, mix them up into a homogeneous melt; and at the same time, (a) propel the melt forward (i.e. towards the affixed die (4)), and (b) extract trapped volatiles, gases and moistures from the melt and drive them out through a series of Venting Ports (3). The homogeneous melt will then be forced through an affixed die (4) and from there it will be extruded as final products.

### (b) The Steps

As a prelude to describing the steps, it is necessary to lay down the meaning of two general notations used here and to explain the purpose for using them. The notation “TSP” is adopted as a reference to thermoset plastic and “TP”, to thermoplastic. General notations are used because the same process can be repeated for any combination of thermoset plastic and thermoplastic with similar end result, i.e. recyclable relivplastic. Relivplastics made of different constituents will possess different physical properties. They will differ in their compressive/elastic strength, surface hardness, conductivity, etc. However, all of them, if produced in the manner described below, are reusable and recyclable.

The steps are as follows:—
1. Grind TSP into fine powder and pre-dry it for 40 minutes at 90° C.
   Notes:
      (a) Grounding the TSP will ease physical mixing of ingredients (i.e. TP and TSP); and increase mix uniformity, later on in the process. Further, in grounded form, the ingredients can melt down completely within a short time span; and in this way the environment would be conducive for a better and more complete chemical reaction to take place. The end result is a product that has a high degree of homogeneity and consistency.
      (b) Moisture, gases and other volatiles will impede/interfere with chemical reactions; and gases will leave air pockets in the final product: And all these would have an adverse impact on quality and usability of the final product. It is of crucial importance to use only dry ingredients. This is the reason for pre-drying the grounded TSP.
      (c) The description “pre-drying” is used for a specific reason. The extruding machine actually has drying capability (more about this later). However, given the importance of using dry ingredients and in order to ensure that the ingredients used are free of moisture this additional step of “pre-drying” is implemented.
2. Measure the quantity of dried TSP powder and TP to be used in the process by weight in the following relative proportion: 75% —TSP; and 20% —TP. The remaining 5% by weight is made up of promoter and lubricant (more details on these two ingredients in step 3).
   Notes:
      (a) The relative proportion mentioned may be varied. Experiments show that the invented process is capable of accepting a very large proportion of TSP. The process can reliably accept at least 70% TSP, by weight, of all ingredients use. In the invention, TSP measuring 75%, by weight, of all ingredients was actually used with predictable and successful result.
      (b) Base on the above proportion, the relivplastic that is produced will be 75% TSP. In short, in terms of composition, relivplastic is very much a thermoset plastic. Even though it is so, the resulting relivplastic behaves like thermoplastic. It can be heated up and melted; and in the course of doing so, undergo physical changes that are similar to thermoplastic. It can also be extruded into profiles as end products, like thermoplastic.
3. Pre-blend the measured quantity of dried TSP powder and TP together with the following two essential ingredients
(1) Polyolefin grafted with functional group.

The amount of Polyolefin grafted with functional group added is about equal to 3%, by weight, of all ingredients used.

### Notes:

(a) Polyolefin grafted with functional group is added to serve as a binding agent/promoter for the two plastic ingredients.
(b) There are many other readily available and comparable chemicals in the market that may be suitable for use here as binding agent/promoter, e.g. chemically modified Polypropypene and chemically modified Polyethylene (just to name two). Each of these chemicals (including Polyolefin grafted with functional group) has its own specific and established use(s). However, in the industry, there are no known account of use being made of these chemicals as binding agent/promoter for thermo plastic and thermoset plastic in the same manner as herein described.
(c) For the purposes of this process, the Polyolefin used must be grafted with a functional group. It is very important to graft with a suitable or appropriate functional group. Polyolefin, by itself, is a type themoplastic. It can react with the TP used to form a polymer. However, in order to trigger a reaction leading to a bondage between TP and TSP the functional group is needed. The functional group that is grafted onto Polyolefin will bind itself to the TSP and will thereby create a link-up between TP and TSP into a polymer chain. The functional group is instrumental in producing the bondage between TP and TSP: It acts as a “bridge” tying the polymers of the two plastics together. The end result of the reaction is that the respective polymers of TP and TSP will become fused together and they will be held in position by the forces of Van Der Vaal.
(2) Lubricants: low molecular weight Polyethylene and Esters of long-chain fatty acids.
The amount to be added is about equal to 2%, by weight, of all ingredients used.

### Notes:

(a) For easy reference, this chemical will be called “lubricating system”. Again, there are many readily available and comparable chemicals in the market that may be suitable for use here. For the purposes of the invented process, the two named lubricants were experimented with and they produced satisfactory results.
(b) Lubricant is added to improve workability of the melt and thereby increase the mix uniformity and consistency of TP, TSP and Polyolefin grafted with functional group; and to ensure homogeneity and quality of the end product, i.e. relivplastic. A non-homogeneous plastic ingredient cannot be soften and moulded easily or properly; and hence cannot be reused and recycled properly or effectively.
(c) All four ingredients (TSP, TP, binding agent/promoter and lubricating system) can be mixed at once.
4. Load all 4 pre-blended ingredients into the Hopper of an extruding machine (similar to the one shown in the drawing).

### Notes:—

(a) In the extruding machine the following processes will take place (in sequence):—
   (i) The 4 pre-blended ingredients will be heated up; and both TP and TSP will be melted down.
   (ii) The molten TP and TSP (together with binding agent/promoter and lubricating system) will be mixed continuously and thoroughly into a homogeneous and consistent melt in the mixing chamber by a pair of counter-rotating cornical screws.
   (iii) Any remaining moisture that may be present or any remaining gases or volatiles that may be trapped in the melt will be extracted and removed.
   (iv) The homogeneous melt (which is free of moisture, gases and volatiles) will be forced through the extruding machine and out of it as pellets (for further processing by injection moulding). If the end of the machine is fitted with a die, then final profiles can be extruded directly.
(b) For optimum result the following processing parameters are used:
   (i) Temperature: Set at 150° C.-170° C. to melt the pre-blended ingredients and then maintain the temperature at that level throughout until the whole process is completed.
   (ii) Turning Speed (Cornical Screws): Turning speed must be controlled and regulated with care. The outlet of the mixing chamber is smaller, in cross-section area, then the inlet. Hence, increasing the turning speed of the cornical screws will increase the pressure that is bearing on the melt inside the mixing chamber (and through the die) and vice versa. The turning speed will affect the flow of the melt. Consistency of the ingredients and hence quality of the final product will likewise be affected by it. For optimum result, the melt pressure will be used as a guide to determine the turning speed. The speed must be regulated and maintained at a level which is sufficient to bring about a pressure of 40 bar on the melt.
   (iii) Current: Set at 60 ampere.

1. The mixture (concoction) of thermoset plastic, thermoplastic, binding agent/promoter and lubricating system used in producing relivplastic;

2. The mixture (concoction) of thermoset plastic, thermoplastic, binding agent/promoter and lubricating system used in converting/turning cured thermoset plastic into reusable and recyclable plastic, i.e. relivplastic.

3. The use of thermoset plastic measuring at least 70% by weight of all ingredients used in claim 1 and claim 2.

4. The use of Polyolefin grafted with functional group (and other similar or comparable chemicals that are appropriately grafted with functional group) as binding agent/promoter to create a bond between thermoplastic and thermoset plastic.

5. The creation of Van Der Vaal bonds between thermoset plastic and thermoplastic by means of a thermoplastic polymer which is grafted with an appropriate functional group.

6. The use of Polyethylene and Esters of long-chain fatty acids (and other similar or comparable chemicals) as lubricating system in easing the mixing process in claim 1 and claim 2; and in improving homogeneity and consistency of the mix and the resulting relivplastic.

7. The Relivplastic which can be heated up, soften and then moulded easily and repeatedly.
